(19) United States
(12) Patent Application Publication
(10) Pub. No.: US 2011/0108500 A1
(43) Pub. Date: May 12, 2011

(54) JOIST HANGER SYSTEM

(76) Inventor: William James Sheffield, Niles, MI (US)

(21) Appl. No.: 12/941,731

(22) Filed: Nov. 8, 2010

Related U.S. Application Data
(60) Provisional application No. 61/260,096, filed on Nov. 11, 2009.

(51) Int. Cl. F16M 13/02; A47F 7/00

(52) U.S. Cl. 211/60.1; 248/214; 211/13.1; 211/71.01

(57) ABSTRACT

A joist mounted storage system having a pair of saddles, each of which rest upon and about adjacent joists. Extending upwardly from the saddles are arms between which pulleys are suspended and supported for the purpose of raising and lowering objects for storage.

### CROSS REFERENCE TO RELATED APPLICATION

This application claims the benefit of U.S. Provisional Application No. 61/260,096, filed Nov. 11, 2009, the disclosure of which is hereby incorporated by reference.

### SUMMARY OF THE INVENTION

This invention relates to a joist hanger.

Garage space is at a premium and maximizing garage space is important to homeowners especially as they accumulate more things to put into the garage. Since floor space is limited, there is an abundance of storage devices used to store objects on garage walls. Thus, wall space is limited. Shelves may be used, however, these consume valuable floor space.

Homeowners limited by available options within arm's reach of the floor sometimes resort to storing objects in the joists at the bottom, of their roof trusses. Boards may be placed across multiple joists on which to store objects. This can be an unsafe endeavor as a homeowner must climb a ladder or climb within the joists. The risk of falling on a concrete floor may not be justifiable.

Ideally, one would be able to store items above the joists without having to climb to the joists. Retrieving the objects should be easily accomplished as well without leaving the ground. The ability to store items above the joists without leaving the ground would maximize the use of space that often would be wasted.

This invention will be installed upon adjacent exposed joists, typically found in a garage or similar structure. Saddles are provided which extend about the joist and from which arms extend upwardly to support between them pulleys by which articles can be raised and lowered between the joists.

Accordingly, it is an object of this invention to provide a joist supported system for storing items in a elevated position.

Another object, of this invention is to provide a storage system which is mounted to adjacent joists in a building structure and between which items may be raised and suspended.

And still another object of this invention is to provide a joist storage system which provides an accommodating space saver for storing items.

Other objects of this invention will become apparent upon the reading of the following description.

### BRIEF DESCRIPTION OF THE DRAWINGS

FIG. 1 is a perspective of the joist hanger system;

FIG. 1A is a top view of the hinge where opposing arms meet;

FIG. 2 is side view of the joist hanger system show in FIG. 1;

FIG. 3 is sectional view taken about the line 3-3 in FIG. 2;

FIG. 3A is a sectional view of the safety catch;

FIG. 4 is a perspective view of the joist hanger system with the boat holding loop accessory;

FIG. 5 is a perspective of the collapsible tree accessory for holding elongate objects;

FIG. 6 is a perspective of the collapsible basket accessory in its descended position; and

FIG. 7 is a side view of the collapsible basket accessory shown in FIG. 7 in its descended position, with broken lines to show how the basket collapses in the unfurled position.

### DETAILED DESCRIPTION OF THE PREFERRED EMBODIMENT

The present invention is a joist hanging system 10 typically used in garages, but could be used elsewhere where space is at a premium. The joist hanging system includes a pair of elongate saddles 12 that are parallel to each other. Each saddle has an upper portion 14 and a pair of legs 16 that extend downwardly from the upper portion. The legs 16 have a lower edge 20 at their lowermost portion that is opposite where the legs 16 attach to the upper portion 14. The legs 16 are resilient and integrally molded with the upper portion 14. The saddle 12 may be molded plastic that is lightweight and durable. The legs 16 are spaced opposite and parallel to each other to form a U-shaped channel between them for receiving a joist 22. When the legs 16 are pushed apart, they will tend to spring back to the width shown in FIG. 3.

Each leg 16 includes safety catches 25 that extend inwardly from inner surfaces 24 of the legs 16. FIGS. 3 and 3A show the safety catches 25. The catches 25 have a ramp surface 26 sloped upwardly and inwardly. A land surface 28 is located above the ramp surface 26 and meets the ramp surface to form a biting edge 30. The land surface forms a corner 32 where it meets the inner surface 24 of the leg 16 from which it extends. The biting edge 30 is at or above the height of the corner 32. The length of the safety catches 25 can be continuous along the length of the saddles 12, or can be periodic for shorter lengths at various positions along the lower edges of the legs 16

The upper portion 14 of the saddles 12 each hold a retaining pin 38 that is press fitted, or integrally molded into the saddles 12 within notches 39. The pins 38 fit into arms 40. The arms 40 extend upwardly from the saddles 12. Each arm 40 has an upper end 42 and a lower end 44. The pin 38 in the lower end 44 of each arm pivotally connects each arm 40 to its respective saddle. The lower end 44 of each arm 40 is convexly rounded and mates with the bottom of its corresponding notch 39 which is concavely rounded. Each arm 40 is opposite another arm, and opposing arms 40 are hingeadly joined at their upper ends 42, pivoting around a round elongate member or rod 46. FIG. IA shows the hinged connection at the upper ends 42 of opposing arms.

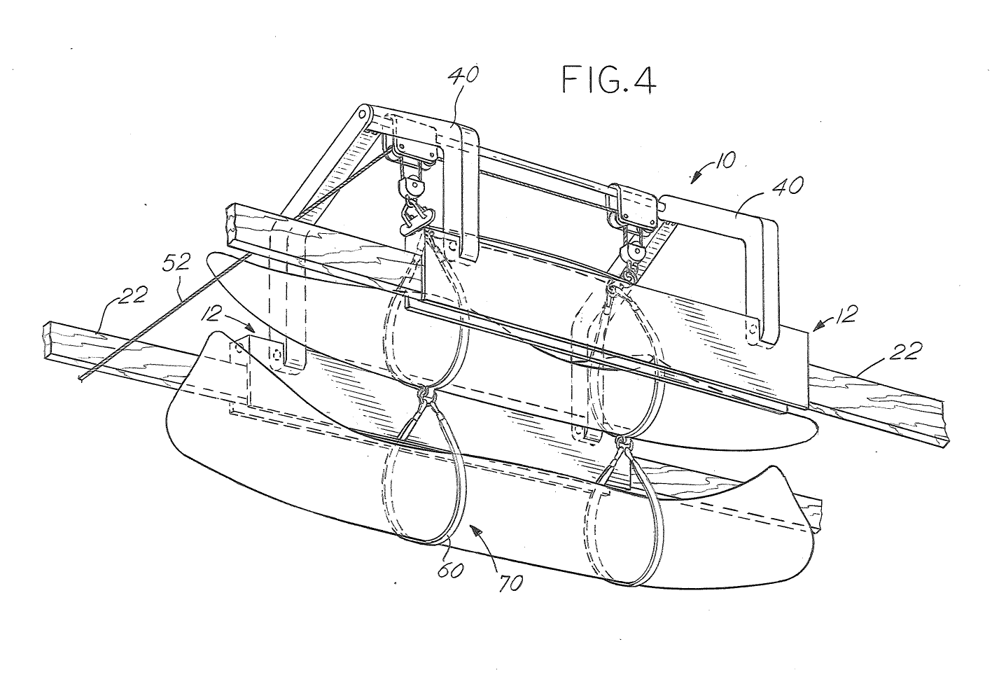

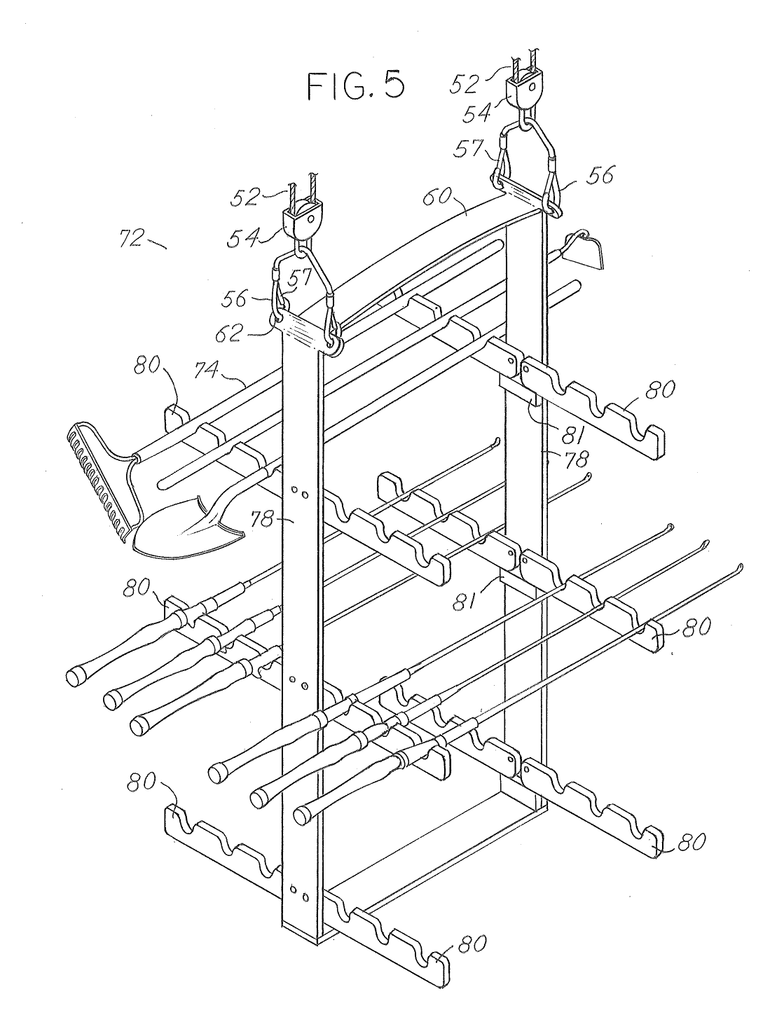

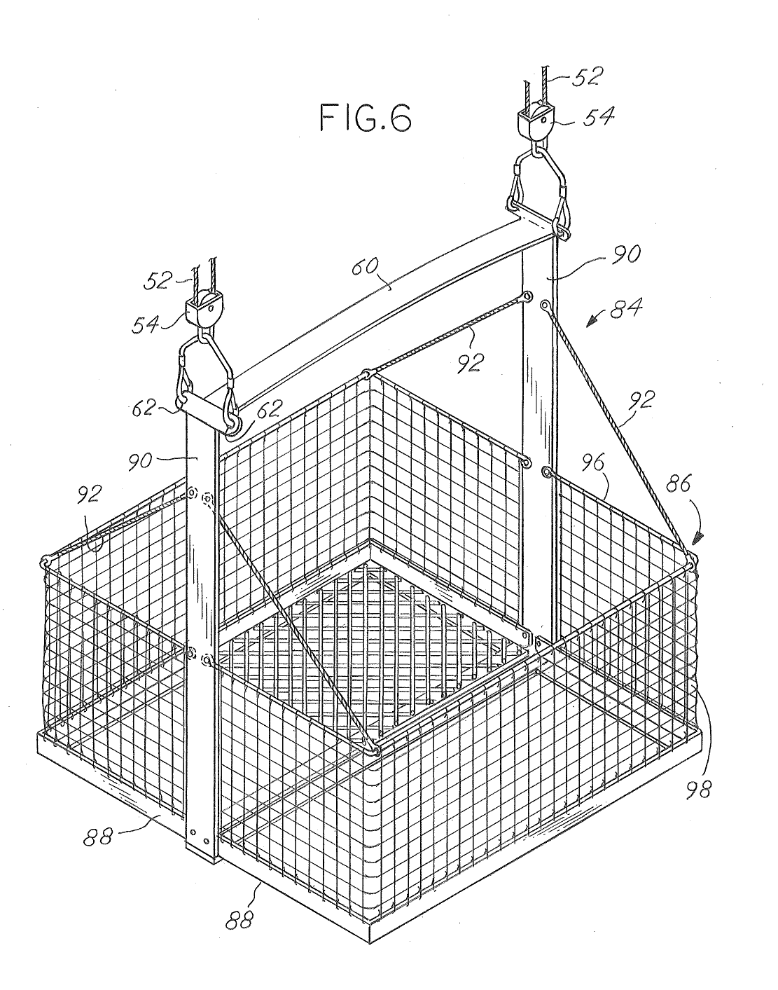

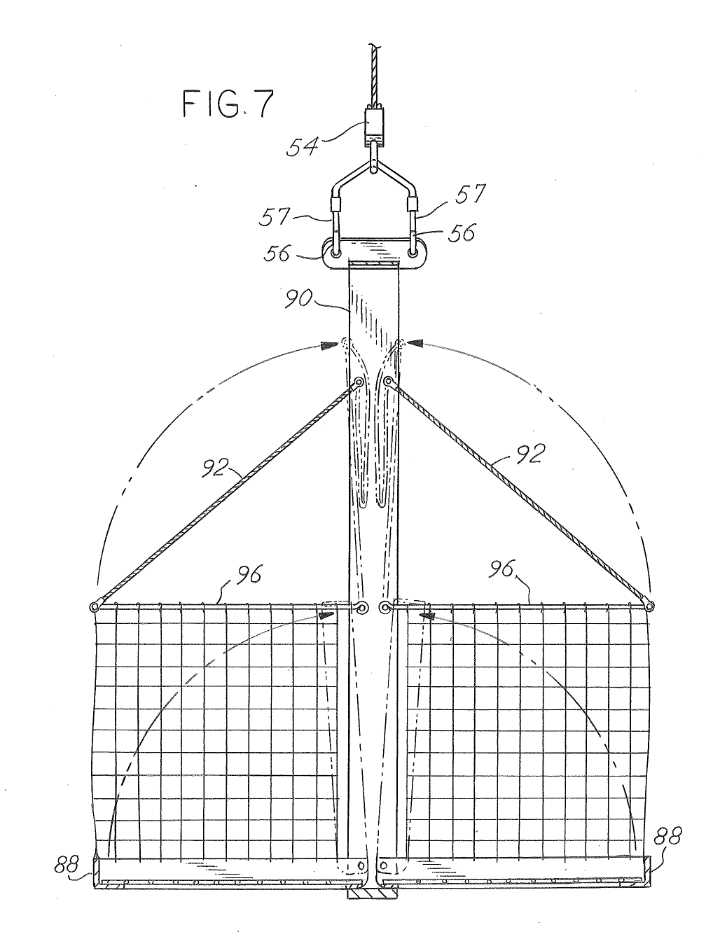

The rod 46 supports a pair of upper pulleys 50 that receive a rope 52. A pair of lower pulleys 54 are suspended on the rope 52. Each of the lower pulleys 54 has a set of hooks 56 and the hooks 56 have a retention member 57 across their open end to prevent objects on them from being accidentally released. The hooks 56 may be used to hang and hoist objects directly, but are also specifically designed to lift accessories. Each accessory has a dog bone 60 structural member having holes 62 for receiving the hooks 56. An accessory 70 that may be used with the joist hanger system 10 includes loops 66 of strap material that may be used to lift kayaks and canoes. This is shown in FIG. 4. Another accessory 72 is a collapsible tree for holding elongate objects 74 such as rakes, shovels, and the like as shown in FIG. 5. This accessory 72 has a dog bone 60 supporting two vertical members 78. The vertical members 78 have support arms 80 that extend laterally and may be folded upward when not in use. When the arms 80 are in their lowered position as shown in FIG. 5, they are supported on stop blocks 81 that hold them in a substantially horizontal position. Another accessory 84 that may be used has a folding basket 86 that has pivotal lower supports 88 that fold down from vertical members 90. This is shown in FIG. 6. The basket 86 is held up by cables 92 attached at one end to the vertical members 90, and at their other end to a pivotable upper bail 96 that holds the netting 98. The aforementioned accessories are merely exemplary and do not constitute the entire universe of possible accessories that may be developed for the joist hanger system 10. All of the accessories 70, 72, 84 are collapsible and therefore may be packaged in a substantially smaller volume than would be taken if they were not collapsible.

Preventing the objects and accessories from falling once they are lifted is accomplished with the use of a safety locking mechanism. This is located on the upper pulley 50′ nearest the free end of the rope. When the rope is pulled upward no resistance is encountered in lifting objects. Additionally, when objects are lowered no resistance will be encountered. However, when objects are lowered faster than a predetermined rate, the locking mechanism will seize and prevent the rope from moving in a downward direction. The predetermined rate of descent will be slower than that of free fall. Thus, when the rope is released and objects suspended by the rope allowed to fall freely, the locking mechanism will prevent the objects from falling.

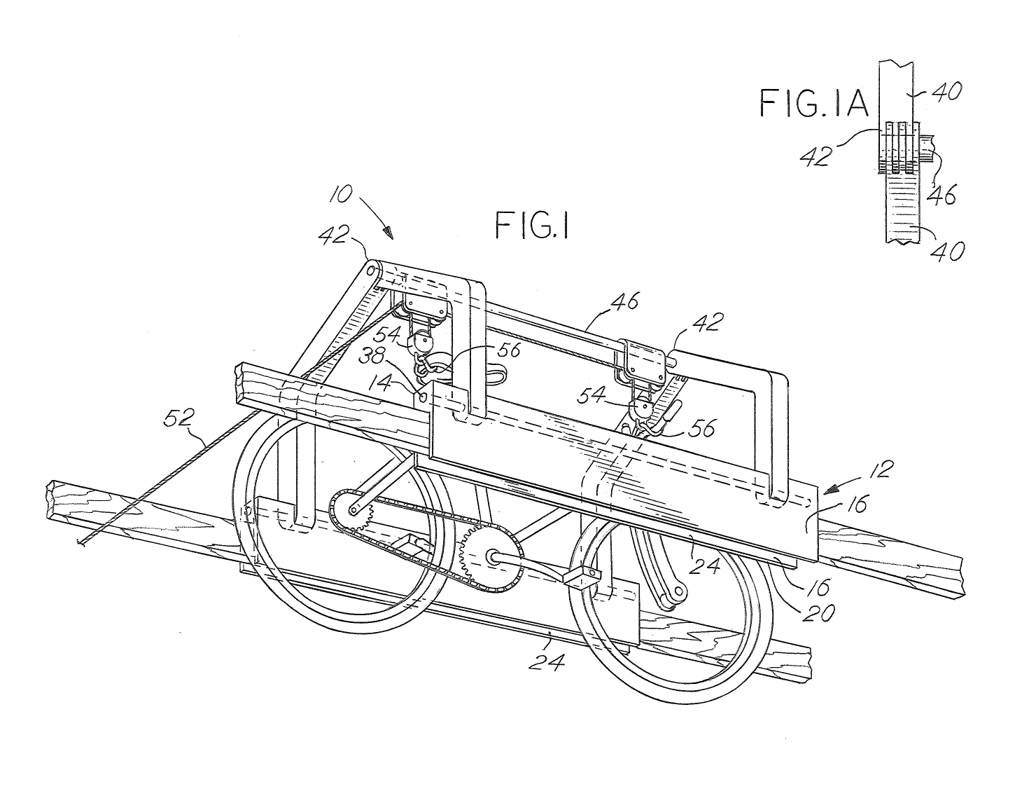

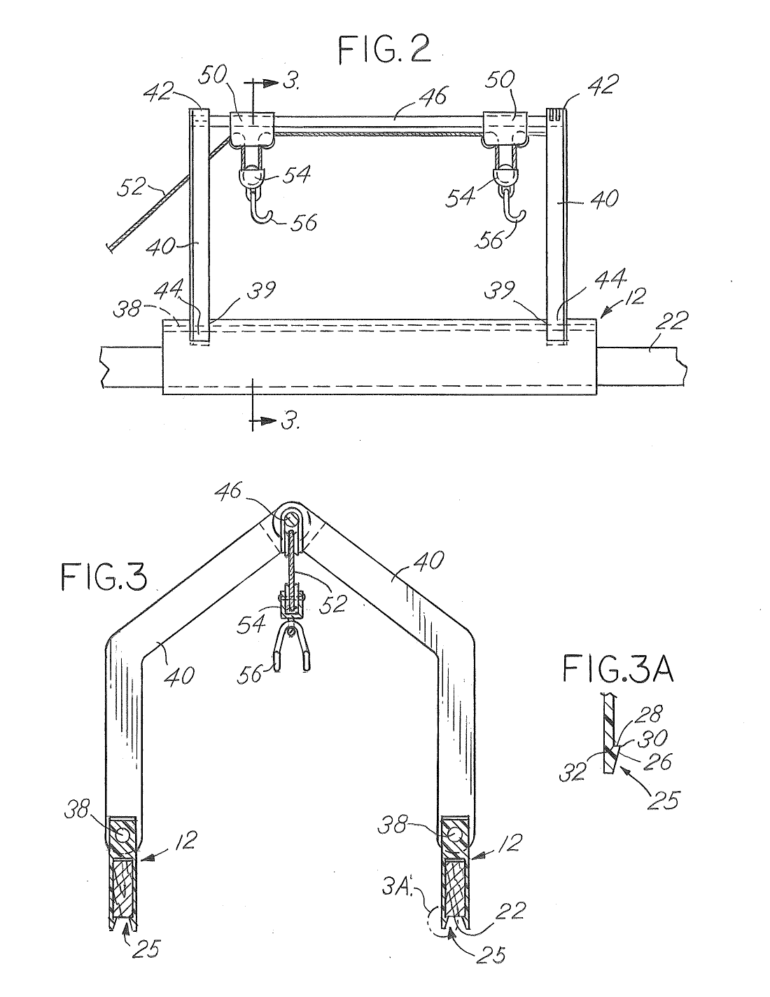

When a user wants to use the joist hanger system 10, typically he will install it into a garage having exposed joists. When the joist hanger is shipped, it will be in a collapsed position with the saddles in contact next to each other and the arms 40 collapsed. The user will then take the joist hanger 10 and move the saddles 12 to the appropriate distance to accommodate the joists 22, which are typically 16 or 24 inches on center. The joist hanger 10 will then be pulled downward onto the joists 22 into the position shown in FIG. 3. The safety catches 25 will have their biting edges 30 below the joists and the resilient legs 16 will maintain the position shown in FIG. 3. As such, the joist hanger system 10 will not be able to move upward accidentally. When a user wishes to remove the joist hanger system 10 from the joists, he will have to spread the legs 16 apart enough so that the biting edges 30 clear the joists 22. In the installed position, the joist hanger system 10 will hold objects above the joists 22 as shown in FIG. 1. Installation and removal are both accomplished without the use of any tools.

After installation, a user will select the accessory 70, 72, 84 for the object he wishes to lift. He will then attach the hooks 56 to the holes in the dog bone 60 of the accessory 70, 72, 84. The user will then pull the rope until the objects he wishes to store are lifted to the desired height. Once the objects are at the desired height, the rope will be tied to an accessible location removed from the joist hanger system 10.

This invention is not limited to the details above, but may be modified within the scope of the following claims.

What is claimed is:

1. A joist hanger system comprising:
a pair of elongate saddles opposite and substantially parallel to each other, each saddle having an upper portion and pair of legs extending from said upper portion in a downward direction, said legs having a lower edge opposite said upper portion, said legs and said upper portion forming a U-shaped channel for receiving a joist; and
at least one arm extending upwardly from each said saddle, each said arm having a lower and upper end, each said arm being pivotally attached to its corresponding saddle at its lower end, said arm from one said saddle being pivotally joined to said arm from the other saddle at their upper ends.

2. A joist hanger as claimed in claim 1, wherein each saddle includes a plurality of arms, each said arm on one of said saddles being opposite another said arm on said opposite saddle, said opposite arms being pivotally connected at their upper ends to form a pair of arms, said pairs of arms supporting an elongate member at their upper ends.

3. A joist hanger as claimed in claim 2, wherein said legs of said saddle include safety catches extending from inner surfaces of said legs, said catches having a ramp surface and a land surface, said ramp surface angled inwardly and meeting said land surface to form a biting edge where said ramp surface and land surface meet, said land surface forming a corner where it meets said inner surface, said biting edge being at or above the height of said corner where said inner surface and said land surface meet.

4. A joist hanger as claimed in claim 3, wherein said lower ends of said arms are convexly rounded and said saddles includes notches for receiving said arms, said notches having a concavely rounded bottom mating with said lower ends of said arms, said lower ends of said arms being pivotable about a pin retained within said saddle.

5. A joist hanger as claimed in claim 4, wherein said elongate member has a round cross section and fits within a bore in said upper ends of said opposite arms, said opposite arms hingeadly joined around said elongate member at their upper ends, thereby allowing said saddles to be selectively moved apart.

6. A joist hanger as claimed in claim 5, wherein said elongate member supports a pulley.

7. A joist hanger as claimed in claim 6, wherein said elongate member supports a plurality of pulleys, said pulleys receiving a cord, and hooks being suspended from said cord.

8. A joist hanger as claimed in claim 7, wherein said hooks are received within a dog bone for holding an accessory.

9. A joist hanger as claimed in claim 8, wherein said accessory is a collapsible tree for holding elongate objects.

10. A joist hanger as claimed in claim 8, wherein said accessory is a pair of loops.

11. A joist hanger as claimed in claim 8, wherein said accessory is a collapsible basket.
